(19) United States
(12) Patent Application Publication
(10) Pub. No.: US 2020/0010669 A1
(43) Pub. Date: Jan. 9, 2020

(54) DIFFUSIVE POLYCARBONATE COMPOSITIONS WITH ENHANCED FLAME RETARDANT PROPERTIES, LUMINOUS EFFICIENCY AND BEAM ANGLE OF OPTICAL COMPONENTS

(71) Applicant: SABIC Global Technologies B.V., Bergen op Zoom (NL)

(72) Inventors: Miao SHEN, Shanghai (CN); Yu DING, Shanghai (CN); Haowei TANG, Shanghai (CN); Jian YANG, Shanghai (CN); Yingjun CHENG, Shanghai (CN); Guangde HUANG, Shanghai (CN); Huihui LI, Shanghai (CN)

(73) Assignee: SABIC Global Technologies B.V., Bergen op Zoom (NL)

(21) Appl. No.: 15/772,706

(22) PCT Filed: Nov. 4, 2015
(86) PCT No.: PCT/CN2015/093780

§ 371 Date: May 1, 2018

(51) Int. Cl. C08L 69/00; C08L 83/04; C08K 5/5419; C08K 5/00; B29C 45/00; C08L 25/12; C08L 27/18

(52) U.S. Cl. CPC C08L 69/00; C08L 83/04; C08K 5/5419; C08K 5/0041; B29K 2069/00; C08K 5/0066; C08L 25/12; C08L 27/18; B29C 45/0001

(57) ABSTRACT

The disclosure concerns optical components comprising a polycarbonate-containing composition, the polycarbonate-containing composition comprising: about 95 wt % to about 99.6 wt % polycarbonate polymer; about 0.25 wt % to about 1 wt % silicon resin; about 0.05 wt % to about 0.5 wt % flame retardant; and about 0.1 wt % to about 0.5 wt % styrene-acrylonitrile copolymer coated polytetrafluoroethylene, wherein the polycarbonate-containing composition exhibits a VO rating at 0.75 mm as determined by the UL94 Flammability test, and wherein the total wt % of all components of the polycarbonate-containing composition does not exceed 100 wt %.

### TECHNICAL FIELD

The disclosure concerns polycarbonate-containing compositions with enhanced flame retardant properties, improved luminous efficiency and beam angle properties and their use in optical components such as LED lens covers.

### BACKGROUND

Due to any industry trend of thinner wall design of LED diffusive components, diffusive engineering plastics which can maintain UL94 VO flammability at thinner wall is desired. Most fire retardant (FR) additives are light absorbing and thus sacrifice luminous efficiency of light components. There is a need in the art for compositions that overcome this deficiency.

### SUMMARY

The disclosure concerns optical component comprising a polycarbonate-containing composition, the polycarbonate-containing composition comprising: about 95 to about 99.6 wt % polycarbonate polymer; about 0.25 to about 1 wt % silicon resin, about 0.05 to about 0.5 wt % flame retardant, and about 0.1 to about 0.5 wt % styrene-acrylonitrile copolymer coated polytetrafluoroethylene, wherein the total wt % of all components of the polycarbonate-containing composition does not exceed 100 wt %.

Some preferred optical components are LED lamp covers.

Some preferred flame retardants comprise at least one compound of the formula

[(R)₂SiO]_{y}

wherein R is a monovalent hydrocarbon or fluorinated hydrocarbon having from 1 to 18 carbon atoms and y is a number from 3 to 12. In some embodiments, the flame retardant is octaphenylcyclotetrasiloxane.

### DETAILED DESCRIPTION OF ILLUSTRATIVE EMBODIMENTS

The disclosure concerns optical component comprising a polycarbonate-containing composition, the polycarbonate-containing composition comprising: about 95 to about 99.6 wt % polycarbonate polymer; about 0.25 to about 1 wt % silicon resin, about 0.05 to about 0.5 wt % flame retardant, and about 0.1 to about 0.5 wt % styrene-acrylonitrile copolymer coated polytetrafluoroethylene, wherein the total wt % of all components of the polycarbonate-containing composition does not exceed 100 wt %.

### Polycarbonate (PC)

Composition disclosed herein comprises about 95 wt % to about 99.6 wt % polycarbonate polymer based on the weight of the composition. In some embodiments, the amount of polycarbonate is about 97 wt % to about 99 wt %. In certain embodiments, at least a portion of the polycarbonate is a branched polycarbonate; about 10 wt % to about 90 wt % branched polycarbonate in some compositions. In other compositions, the amount of branched polycarbonate is about 20 wt % to about 80 wt % or about 30 wt % to about 70 wt % or about 40 wt % to about 60 wt %, or about 50 wt %, based on the weight of the composition.

Some branched polycarbonate is produced from reagents comprising bisphenol A and 1,1,1-tris-(4-hydroxyphenylethane).

The terms “polycarbonate” or “polycarbonates” as used herein includes copolycarbonates, homopolycarbonates and (co)polyester carbonates. PC polymers are available commercially from SABIC.

The term polycarbonate can be further defined as compositions have repeating structural units of the formula (1):

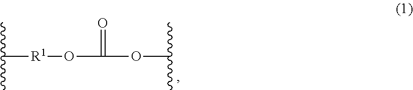

in which at least 60 percent of the total number of R¹ groups are aromatic organic radicals and the balance thereof are aliphatic, alicyclic, or aromatic radicals. In a further aspect, each R1 is an aromatic organic radical and, more preferably, a radical of the formula (2):

-A¹-Y1-A²- (2),

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y1 is preferably a hydrocarbon group or a saturated hydrocarbon group such as methylene, cyclohexylidene, or isopropylidene. Polycarbonate materials include materials disclosed and described in U.S. Pat. No. 7,786,246, which is hereby incorporated by reference in its entirety for the specific purpose of disclosing various polycarbonate compositions and methods for manufacture of the same.

Generally polycarbonates can have a weight average molecular weight (Mw), of greater than about 5,000 g/mol based on PS standards. In one aspect, the polycarbonates can have an Mw of greater than or equal to about 20,000 g/mol, based on PS standards. In another aspect, the polycarbonates have an Mw based on PS standards of about 20,000 to 100,000 g/mol, including for example 30,000 g/mol, 40,000 g/mol, 50,000 g/mol, 60,000 g/mol, 70,000 g/mol, 80,000 g/mol, or 90,000 g/mol. In still further aspects, the polycarbonates have an Mw based on PS standards of about 22,000 to about 50,000 g/mol. In still further aspects, the polycarbonates have an Mw based on PS standards of about 25,000 to 40,000 g/mol.

In certain embodiments, the polycarbonate may comprise two or more polycarbonate compositions that differ in molecular weight and/or compositional variations.

Certain polycarbonates are sold under the trade name LEXAN™ by SABIC Innovative Plastics of Pittsfield, Mass.

### Silicon Resin

Compositions disclosed herein comprise about 0.25 to about 1 wt % silicon resin based on the weight of the composition. Certain compositions comprise 0.4 to about 0.8 wt % of silicon resin.

Useful silicones include polymerized siloxanes Examples include silicone oil and octaphenylcyclotetrasiloxane.

### Flame Retardant

Compositions of the disclosure comprise about 0.05 to about 0.5 wt % flame retardant based on the weight of the composition. In some embodiments, about 0.1 wt % to about 0.4 wt % of flame retardant is present in the composition.

Certain flame retardant comprise at least one compound of the formula

[(R)₂SiO]_{y}

wherein R is a monovalent hydrocarbon or fluorinated hydrocarbon having from 1 to 18 carbon atoms and y is a number from 3 to 12. One preferred flame retardant is octaphenylcyclotetrasiloxane.

### Styrene-Acrylonitrile Copolymer Coated Polytetrafluoroethylene

The compositions of the disclosure comprise about 0.1 to about 0.5 wt % styrene-acrylonitrile copolymer coated polytetrafluoroethylene. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer.

### Phosphors

Phosphors, also known as “luminescent conversion materials”, can be compounded into the polycarbonate compositions disclosed herein. In one aspect, the phosphor material is configured to convert light emitted by a light source such as a light-emitting diode (LED) into light having a different wavelength. For example, the phosphor material may be configured to convert the light emitted by an LED to a higher or lower wavelength as needed.

Phosphors are typically inorganic compounds. Examples of phosphor materials include yttrium aluminum garnet (YAG) doped with rare earth elements, terbium aluminum garnet doped with rare earth elements, silicate (BOSE) doped with rare earth elements; nitrido silicates doped with rare earth elements; nitride orthosilicate doped with rare earth elements, and oxonitridoaluminosilicates doped with rare earth elements. Quantum dots comprising inorganic materials, usually cadmium based phosphorescent compounds may also be used to form opaque and translucent polycarbonates.

The phosphor material is typically in the form of a solid powder. The phosphor material may include red-emitting phosphors, green-emitting phosphors, and yellow-emitting phosphors. In one aspect, the phosphor material may comprise a mixture of two or more of red-emitting phosphor, green-emitting phosphor and yellow-emitting phosphor.

In some embodiments, the phosphor material can comprise Si, Sr, Ba, Ca, Eu, Y, Tb, B, N, Se, Ti, or a combination comprising at least one of the foregoing. The phosphor can comprise greater than 0 ppm of a first material comprising Si, Sr, Ba, Ca, Eu, or a combination comprising at least one of the foregoing; and less than 50 ppm of a second material comprising Al, Co, Fe, Mg, Mo, Na, Ni, Pd, P, Rh, Sb, Ti, Zr, or a combination comprising at least one of the foregoing based on the total weight of the phosphor. The phosphor can comprise greater than 0 ppm of a first material consisting of Si, Sr, Ba, Ca, Eu, or a combination comprising at least one of the foregoing; and less than 50 ppm of a second material consisting of Al, Co, Fe, Mg, Mo, Na, Ni, Pd, P, Rh, Sb, Ti, Zr, or a combination comprising at least one of the foregoing based on the total weight of the phosphor.

The phosphor can comprise a yttrium aluminum garnet, a terbium aluminum garnet, a boron silicate; a nitrido silicates; a nitride orthosilicate, a oxonitrido aluminosilicates, or a combination comprising at least one of the foregoing. The phosphor can comprise a strontium silicate yellow phosphor, a yttrium aluminum garnet, a terbium aluminum garnet, a silicate phosphor, a nitride phosphor; a nitrido silicate, a nitride orthosilicate, an oxonitridoaluminosilicate, an alumino nitrido silicate, a nitridoaluminate, a lutetium aluminum garnet, or a combination comprising at least one of the foregoing. The alumino nitrido silicate can comprise CaAlSiN₃:Eu that can be free of Sr (i.e., can comprise 0 wt % of Sr), (Sr,Ca)AlSiN₃:Eu), or a combination comprising at least one of the foregoing.

The phosphor can comprise a lutetium aluminum garnet containing at least one alkaline earth metal and at least one halogen dope with a rare earth element.

The phosphor can comprise a rare earth element, cerium³⁺ or europium²⁺ for example, as a dopant.

In certain embodiments, the phosphor can comprise green-emitting lutetium aluminate phosphor comprising lutetium, cerium, at least one alkaline earth metal, aluminum, oxygen, and at least one halogen.

Some phosphor materials can convert some of the blue light from a blue LED to yellow light, and the overall combination of available light is perceived as white light to an observer.

The phosphor can comprise a phosphor having formula: (A³)₂SiO₄:Eu²⁺D¹, where A³ is a divalent metal selected from Sr, Ca, Ba, Mg, Zn, Cd, and combinations comprising at least one of the foregoing, and D¹ is a dopant selected from F, Cl, Br, I, P, S or N, and optionally combinations comprising at least one of the foregoing.

The phosphor can comprise a phosphor having formula: (A⁴)₂SiO₄:Eu²⁺D² with an optional dopant selected from Al, Co, Fe, Mg, Mo, Na, Ni, Pd, P, Rh, Sb, Ti or Zr, and optionally combinations comprising at least one of the foregoing, wherein A⁴ is selected from Sr, Ba, Ca, and combinations comprising at least one of the foregoing.

The phosphor can comprise a phosphor having formula: (YA⁵)₃(AlB)₅(OD³)₁₂:Ce³⁺, where A⁵ is a trivalent metal selected from Gd, Tb, La, Sm, or a divalent metal ion such as Sr, Ca, Ba, Mg, Zn, Cd, and combinations comprising at least one of the foregoing; B is selected from Si, B, P, and Ga, and optionally combinations comprising at least one of the foregoing; and D³ is a dopant selected from F, Cl, Br, I, P, S or N, and optionally combinations comprising at least one of the foregoing. Other possible yellow material(s) include: Y₃Al₅O₁₂:Ce; Tb₃₋ₓREₓAl₅O₁₂:Ce (TAG), wherein RE=Y, Gd, La, Lu; Sr_{2-x-y}BaₓCa_{y}SiO₄:Eu; Sr₃₋ₓSiO₅:Eu²⁺ₓ, wherein 0<x≤1. Possible yellow/green material(s) include: (Sr,Ca,Ba)(Al,Ga)₂S₄:Eu²⁺; Ba₂(Mg,Zn)Si₂O₇:Eu²⁺; Gd_{0.46}Sr_{0.31}Al_{1.23}OₓF_{1.38}:Eu²⁺_{0.06}; (Ba_{1-x-y}SrₓCa_{y})SiO₄:Eu; and Ba₂SiO₄:Eu²⁺.

The phosphor material can comprise a phosphor having formula: (YGd)₃Al₅O₁₂:Ce3+ or Y₃Al₅(OD³)₁₂:Ce³⁺.

The phosphor can comprise an orange-red silicate-based phosphor(s) having formula: (SrM1)₃Si(OD⁴)₅:Eu, where M1 is selected from Ba, Ca, Mg, Zn, and combinations comprising at least one of the foregoing; and D⁴ is selected from F, Cl, S, and N, and optionally combinations comprising at least one of the foregoing; phosphor(s); a Eu²⁺ doped and or Dy³⁺ phosphor(s) having formula: M₃MgSi₂O₈, wherein M is selected from Ca, Sr, Ba, and combinations comprising at least one of the foregoing.

The phosphor can comprise a red silicon nitride based Eu²⁺ doped phosphor(s) having a formula: (SrM₂)₂Si₅N₈, where M2 is selected from Ca, Mg, and Zn and combination comprising at least one of the foregoing. Other nitridosilicates, oxonitridosilicates, oxonitridoaluminosilicates examples include: Ba₂SiN₈:Eu²⁺; alpha-SiAlON:Re (Re=Eu²⁺, Ce³⁺, Yb^{2+,} Tb³⁺, Pr³⁺, Sm³⁺, and optionally combinations comprising at least one of the foregoing); Beta-SiAlON:Eu²⁺; Sr₂Si₅N₈:Eu²⁺,Ce³⁺; a rare earth doped red sulfide based phosphor (such as (SrM3)S, where M3 is selected from Ca, Ba, and Mg, and optionally combinations comprising at least one of the foregoing); SrₓCa₁₋ₓS:Eu,Y, wherein Y is a halide; CaSiAlN₃:Eu²⁺; Sr_{2-y}Ca_{y}SiO₄:Eu; Lu₂O₃:Eu³⁺; (Sr₂₋ₓLaₓ)(Ce₁₋ₓEuₓ)O₄; Sr₂Ce₁₋ₓEuₓO₄; Sr₂₋ₓEuₓCeO₄; SrTiO₃:Pr³⁺,Ga³⁺; CaAlSiN₃:Eu²⁺; Sr₂Si₅N₈:Eu²⁺, or a combination comprising at least one of the foregoing.

The phosphor can comprise a blue phosphor such as BaMgAl₁₀O₁₇:Eu²⁺.

The phosphor can comprise a green sulfide based phosphor such as (SrM3)(GaM4)₂S₄:Eu; where M3 is set forth above, and M4 is selected from Al and In.

The phosphor can comprise Tb₃₋ₓRE¹ₓO₁₂:Ce(TAG), wherein RE¹ is selected from Y, Gd, La, Lu, and combinations comprising at least one of the foregoing; yttrium aluminum garnet (YAG) doped with cerium (e.g., (Y,Gd)₃Al₅O₁₂:Ce³+; YAG:Ce); terbium aluminum garnet doped with cerium (TAG:Ce); a silicate phosphor material (e.g., (Sr)₂SiO₄:Eu, (Ba)₂SiO₄:Eu, (Ca)₂SiO₄:Eu); a nitride phosphor material (e.g., doped with cerium and/or europium); a nitrido silicate (e.g., LaSi₃N₅:Eu²⁺, O²⁻ or Ba₂Si₅N₈:Eu²⁺); a nitride orthosilicate (e.g., such as disclosed in DE 10 2006 016 548 A1); or combinations comprising at least one of the foregoing. The coated YAG:Ce based phosphor material(s) can be synthetic aluminum garnets, with garnet structure A₃³⁺B₅³⁺O₁₂²⁻ (containing Al₅O₁₂⁹⁻ and A is a trivalent element such as Y³⁺). The aluminum garnet can be synthetically prepared in such a manner (annealing) as to impart a short-lived luminescence lifetime lasting less than 10⁻⁴ s. Other possible green phosphor material(s) include: SrGa2S₄:Eu, Sr_{2-y}BaySiO₄:Eu, SrSiO₂N₂:Eu, and Ca₃Si₂O₄N₂:Eu²⁺.

The phosphor can comprise a yellow phosphor(s) (such as (Y,Gd)₃Al₅O₁₂:Ce3+ or (Sr,Ba,Ca)₂SiO₄:Eu) and a red phosphor material(s) (such as (Sr,Ca)AlSiN₃:Eu), e.g., to produce a warm white light. The phosphor material(s) comprise combinations of a green aluminate (GAL) and a red phosphor material(s) (e.g., to produce white light from the RGB of blue led, green light, and red light). Green aluminate and a red nitride phosphor can be used alone or combined to generate white light when exposed to blue LED light. The red nitride phosphor material can contain ions to promote quantum efficiency. The phosphor material can comprise a combination of a semiconductor nanocrystals of cadmium sulfide mixed with manganese; and/or a La₃Si₆N₁₁:Ce³⁺. A YAG:Ce phosphor material or a BOSE (boron ortho-silicate) phosphor, for example, can be utilized to convert the blue light to yellow. A reddish AlInGaP LED can be included to pull yellow light from the phosphor to the black body curve.

The phosphor can comprise a down converting agent (such as (py)₂₄Nd₂₈F₆₈(SePh)₁₆, where py is pyridine), an up converting agent (such as 0.2 wt % Ti²⁺:NaCl and 0.1 wt % Ti²⁺:MgCl₂), or a combination comprising one or both of the foregoing. The phosphor can comprise an organic dye (such as Rhodamine 6G, Lumogen™ 083), a quantum dot, a rare earth complex, or a combination comprising one or more of the foregoing. The organic dye molecules can be attached to a polymer backbone or can be dispersed in the radiation emitting layer. The phosphor can comprise a pyrazine type compound having a substituted amino and/or cyano group, pteridine compounds such as benzopteridine derivatives, perylene type compounds, anthraquinone type compounds, thioindigo type compounds, naphthalene type compounds, xanthene type compounds, or a combination comprising one or more of the foregoing. The phosphor can comprise pyrrolopyrrole cyanine (PPCy), a bis(PPCy) dye, an acceptor-substituted squaraine, or a combination comprising one or more of the foregoing. The pyrrolopyrrole cyanine can comprise BF₂-PPCy, BPh₂-PPCy, bis(BF₂-PPCy), bis(BPh₂-PPCy), or a combination comprising one or more of the foregoing. The phosphor can comprise a lanthanide-based compound such as a lanthanide chelate. The phosphor can comprise a chalcogenide-bound lanthanide. The phosphor can comprise a transition metal ion such as one or both of Ti²⁺-doped NaCl and Ti²⁺-doped MgCl₂.

The phosphor can comprise a combination comprising at least one of the foregoing phosphors.

The phosphor can be free of an aluminum spinel, wherein a spinel has the structure A²⁺B₂³⁺O₄²⁻ (Al₂O₄²⁻ and A is a divalent alkaline earth element such as Ca²⁺, Sr²⁺, and Ba²⁺).

The polymer composition can comprise 0.5 to 20 wt %, or 1 to 10 wt %, or 3 to 8 wt % of the phosphor based on the total weight of the composition. The polymer composition can comprise 0.1 to 40 parts by weight (pbw), or 4 to 20 pbw of the phosphor based on 100 pbw of polymer.

The phosphor can have a median particle size of 10 nanometers (nm) to 100 micrometers (μm), as determined by laser diffraction. The median particle size is sometimes indicated as D₅₀-value. The median particle size can be 1 to 30 micrometers, or 5 to 25 micrometers. Examples of median particle sizes include 1 to 5 micrometers, or 5 to 10 micrometers, or 11 to 15 micrometers, or 16 to 20 micrometers, or 21 to 25 micrometers, or 26 to 30 micrometers, or 31 to 100 micrometers.

The phosphor can be sized such that it does not reduce the transparency of the radiation emitting layer, for example, the phosphor can be one that does not scatter visible light, or light with a wavelength of 390 to 700 nanometers (nm). The phosphor can have a longest average dimension of less than or equal to 300 nm, or less than or equal to 100 nm, or less than or equal to 40 nm, or 1 to 35 nm.

The phosphor can be coated (e.g., result of applying a material to the surface of the phosphor, wherein the coating is on the surface and/or chemically interacts with the surface). Radiometric values (such as radiant power, radiant intensity, irradiance, and radiance) and corresponding photometric values (such as total luminance flux, luminous intensity, illuminance, luminance), luminance efficacy (in lumens per watt (lm/W)), color rendering index, color quality scale (CQS), correlated color temperature, and chromaticity, can improve compared to the uncoated phosphor(s) when added to a polymer material such as polycarbonate.

The phosphor can be coated with a silicone oil and/or a layer of amorphous silica. Some examples of silicone oils include, but are not limited to: hydrogen-alkyl siloxane oil; polydialkyl siloxane oil; polydimethyl siloxane codiphenyl siloxane, dihydroxy terminated (such as Gelest PDS 1615 commercially available from Gelest, Inc.); as well as combinations comprising at least one of the foregoing. Such silicone oils are considered coatings where the phosphor is first treated with the silicone oil(s) prior to addition to a matrix or binder (collectively referred to as matrix), such as polycarbonate. The coating itself, is neither the binder nor the matrix that contains the phosphor to hold in place for exposure to blue LED radiation. Additionally, the coating does not require a curing method.

The phosphor can be coated with silicone oil e.g., by a method such as spraying the silicon oil. For example, the phosphor can be coated by spraying of the silicone oil in a fluidized bed reactor. The total amount of silicone oil can be 0.05 to 10 wt % with respect to the phosphor, or 0.1 to 10 wt %, or 0.5 to 5 wt %, based upon the total weight of the phosphor. When two silicone coatings are used, such as polymethylhydrosiloxane and polydimethylsiloxane, the total amount does not change, and the split ratio between the two oils can be 1:99 to 99:1. The first coating can represent at least about 50 wt % of the total silicone oil content.

Some examples of oils include polymethylhydrosiloxane (for example, DF 1040 commercially available from Momentive Performance Materials) and polydimethyl siloxane (e.g., DF581 commercially available from Momentive Performance Materials). Other examples include diphenyl siloxane, e.g., silanol terminated oils such as silanol terminated diphenylsiloxane (e.g., PDS-1615 commercially available from Gelest, Inc., Morrisville, Pa.). The polymer composition can comprise up to 4 parts per hundred (pph) by weight, or 0.1 to 0.5 (e.g., 0.2) pph by weight of a pigment (e.g., Gelest PDS-1615). Other possible silanol terminated siloxanes include PDS-0338 and PDS-9931 also commercially available from Gelest, Inc. The polymer composition can comprise less than or equal to 20 pbw of coated phosphor to 100 pbw of polymer.

Additional phosphors include Quantum dots including semiconductor nanocrystal. Such materials include Cd-based, Cd-based core/shell passivated with ZnS shell, alloyed quantum dots such as CdSeTe, InP, InP/ZnS core/shell and ZnSe/InP/ZnS core/shell/shell, CuInS2, ZnS—CuInS2 alloy with ZnS shell, and CuInS₂/ZnS core/shell materials. Yet other phosphors are manganese based phosphors such as K₂SiF₆:Mn⁴⁺; K₂(TaF₇):Mn⁴⁺; KMgBO₃:Mn^{2+.} Phosphors also include narrow band red phosphor: Sr[LiAl₃N₄]:Eu²⁺. A narrow-band phosphor, FWHM 25-35 nm, preferably <30 nm, absorbs 450 nm light, relative quantum yield greater than or equal to 90% (at least 150° C./25° C.), prefer greater of equal to 95%, and quantum yield loss to thermal quenching less than 10% at 150° C. Phosphors include carbidonitride- and oxycarbidonitride-based phosphors. Other phosphors may be of the formula CaAlSiN₃:Eu.

### Other Additives

Other optional additives include one or more of anti-oxidant, UV stabilizer, plasticizers, lubricants and mold release agent. The compositions can include various additives ordinarily incorporated into polymer compositions of this type, with the proviso that the additive(s) are selected so as to not significantly adversely affect the desired properties of the thermoplastic composition (good compatibility for example). Such additives can be mixed at a suitable time during the mixing of the components for forming the composition.

There is considerable overlap among plasticizers, lubricants, and mold release agents, which include, for example, glycerol tristearate (GTS), phthalic acid esters (e.g., octyl-4,5-epoxy-hexahydrophthalate), tris-(octoxycarbonylethyl)isocyanurate, tristearin, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); esters, for example, fatty acid esters (e.g., alkyl stearyl esters, such as, methyl stearate, stearyl stearate, and the like), waxes (e.g., beeswax, montan wax, paraffin wax, or the like), or combinations comprising at least one of the foregoing plasticizers, lubricants, and mold release agents. These are generally used in amounts of 0.01 to 5 wt %, based on the total weight of the polymer in the composition.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec) or combinations comprising at least one of the foregoing light stabilizers. The UV stabilizers can be present in an amount of 0.01 to 1 wt %, specifically, 0.1 to 0.5 wt %, and more specifically, 0.15 to 0.4 wt %, based upon the total weight of polymer in the composition.

Antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of 0.01 to 0.1 parts by weight, based on 100 parts by weight of the total composition.

### Optical Component

Optical components can be formed by conventional means known in the art. In some embodiments, the optical component is formed by conventional molding techniques. In one embodiment, the molding techniques include, without limitation, injection molding, blow molding, and compression molding. Molded articles may also be prepared from a compositional blend described herein. Such blends may be prepared using extrusion methods may be molded using conventional techniques. In certain embodiment, the molded article is prepared using injection molding.

Some optical components comprise a polycarbonate-containing composition that exhibits a VO rating at 0.75 mm as determined by the UL94 Flammability test. Certain optical components comprise a polycarbonate-containing composition that exhibits one or both of (i) an increased beam angle versus an analogous composition having no styrene-acrylonitrile copolymer coated polytetrafluoroethylene and (ii) increased luminous efficiency versus an analogous composition having no styrene-acrylonitrile copolymer coated polytetrafluoroethylene.

Optical components include LED lamp covers.

### Examples

The following examples are intended to be illustrative and not limiting.

LUX9616G (Lexan from SABIC) was selected as the control. It is a 1.5 mm V0 PC consisting of polycarbonate (THPE based branched PC from high purity BPA2, SABIC), polycarbonate (high purity PC 175, SABIC), polycarbonate (high purity PC 105, SABIC), potassium perfluorobutane sulfonate (Bayowet C4, Lanxess), octaphenylcyclotetrasiloxane (SX-12-B, Shin-Etsu), pentaerythritol tetrastearate (Alkanox 240, Chemtura), tris(2,4-ditert-butylphenyl) phosphite (Alkanox 240, BASF), Cyasorb UV 3638 (Cyasorb UV-3638F, Cytec), Octadecyl3(3,5ditertbutyl4hydroxyphenyl)propionate (hindered phenol anti-oxidant) (IRGANOX 1076, Ciba). Polycarbonate was used as base resin, Cyasorb UV 3638 worked as UV stabilizer, tris(2,4-ditertbutylphenyl) phosphite and Octadecyl3(3,5ditertbutyl4hydroxyphenyl)propionate (hindered phenol anti-oxidant) were antioxidants, pentaerythritol tetrastearate was employed as mold release agent, potassium perfluorobutane, sulfonate and octaphenylcyclotetrasiloxane were FR additives. TSAN was incorporated into the composite to further improve FR performance.

TSAN loading from 0 to 0.25 pph were screened in the presence of 0.5 pph silicone resin beads as diffuser (Tospearl 120 from Momentive). Additionally, composites with 0.2 pph TSAN were compared with non-TSAN composites LUX9616G at several diffusion levels.

For FR comparison, 1.0 mm and 0.75 mm UL bars were molded and tested following UL94 standard. For optical comparison, A60 bulbs with 1.0/0.8 mm wall thickness were molded for luminous efficiency and beam angle.

The composites were prepared from twin screw extruder with detailed compounding profile presented in Table 1.

TABLE 1
Compounding profile

| Parameters | Unit | Polycarbonate Composites |
|---|---|---|
| Compounder Type | NONE | TEM-37BS |
| Barrel Size | mm | 1500 |
| Screw Design | NONE | L-3-2 |
| Die | mm | 3 |
| Feed (Zone 0) Temp | ° C. | 50 |
| Zone 1 Temp | ° C. | 50 |
| Zone 2 Temp | ° C. | 100 |
| Zone 3 Temp | ° C. | 270 |
| Zone 4 Temp | ° C. | 270 |
| Zone 5 Temp | ° C. | 270 |
| Zone 6 Temp | ° C. | 270 |
| Zone 7 Temp | ° C. | 270 |
| Zone 8 Temp | ° C. | 270 |
| Zone 9 Temp | ° C. | 270 |
| Zone 10 Temp | ° C. | 270 |
| Zone 11 Temp | ° C. | 270 |
| Die Temp | ° C. | 270 |
| Screw speed | rpm | 400 |
| Throughput | kg/hr | 40 |

The UL bar molding profile is shown in Table 2.

TABLE 2
Molding profile

| Molding Machine | NONE | |
|---|---|---|
| Nestal Mold Type (insert) | NONE | |
| UL bar Cnd: Pre-drying time | Hour | 3 |
| Cnd: Pre-drying temp | ° C. | 120 |
| Hopper temp | ° C. | 50 |
| Zone 1 temp | ° C. | 270-280 |
| Zone 2 temp | ° C. | 275-285 |
| Zone 3 temp | ° C. | 280-290 |
| Nozzle temp | ° C. | 275-285 |
| Mold temp | ° C. | 50-85 |
| Screw speed | rpm | 100 |
| Back pressure | kgf/cm² | 50-80 |
| Cooling time | s | 15 |
| Injection speed (mm/s) | mm/s | 30-150 |
| Holding pressure | kgf/cm² | 600-800 |
| Max. Injection Pressure | kgf/cm² | 1000-1200 |

Table 3 presents FR and optical performance of composites with TSAN loading from 0 to 0.25 pph in the presence of 0.5 pph silicone resin beads.

TABLE 3
TSAN loading screening

| Item | Item Code | Item Description | Unit | C1 | E1 | E2 | E3 |
|---|---|---|---|---|---|---|---|
| PC | 91982 | THPE based branched | pph | 66 | 66 | 66 | 66 |
| | | PC | | | | | |
| PC | 91761 | High purity PC 175 | pph | 32.045 | 32.045 | 32.045 | 32.045 |
| PC | 91061 | High Purity PC | pph | 1 | 1 | 1 | 1 |
| Additive | F4455 | Potassium | pph | 0.08 | 0.08 | 0.08 | 0.08 |
| | | perfluorobutane, | | | | | |
| Additive | F491 | Octaphenylcyclotetrasilo | pph | 0.35 | 0.35 | 0.35 | 0.35 |
| Additive | F538 | Pentaerythritol | pph | 0.35 | 0.35 | 0.35 | 0.35 |
| Additive | F542 | Phosphite stabilizer | pph | 0.06 | 0.06 | 0.06 | 0.06 |
| Additive | F6525 | Cyasorb UV-3638 | pph | 0.095 | 0.095 | 0.095 | 0.095 |
| Additive | F527 | Hindered phenol anti- | pph | 0.02 | 0.02 | 0.02 | 0.02 |
| | | oxidant | | | | | |
| Diffuser | R010722 | Tospearl 120 | pph | 0.5 | 0.5 | 0.5 | 0.5 |
| TSAN | F449 | SAN encapsulated PTFE | pph | 0 | 0.1 | 0.2 | 0.25 |
| Typical Property | Test Method | Test Description | Unit | C1 | E1 | E3 | E4 |
| MFR | ASTM D 1238 | 300° C./1.2 kg/300 s | g/10 min | 7.49 | 7.28 | 8.6 | 6.89 |
| Luminous | Integrating | — | % | 83.8 | 93.2 | 92.7 | 93.2 |
| Beam Angle | Goniophotomet | — | degree | 183.2 | 194.4 | 200.0 | 208.2 |
| No. of burning | UL94 | — | — | 1 | 2 | 0 | 0 |
| drops | | | | | | | |
| p(FTP)V0 | UL94 | — | — | 0.24 | 0.19 | 0.70 | 0.69 |
| FOT 5 | | | s | 41.5 | 55.2 | 35.0 | 39.1 |

It is observed that with the increase of TSAN loading, 1 mm % T of flat color chip drops. This is in accordance with general knowledge. TSAN increases scattering when incorporated into PC, which leads to less transmitted light.

With 0.2 pph TSAN, FR performance is significantly improved. The composites contain 0.2+ pph TSAN can pass 1.0 mm VO test.

The addition of 0.1 pph TSAN significantly improves luminous efficiency. However, when the loading is further elevated from 0.1 to 0.25 pph, there is no further improvement in luminous efficiency.

Inclusion of TSAN increases beam angle.

Table 4 presents optical evaluation of 0.2 pph TSAN in different diffusion levels.

TABLE 4

| Item | Item Code | Item Description | Unit | C2 | E4 | C3 | E5 | C4 | E6 |
|---|---|---|---|---|---|---|---|---|---|
| PC | 91982 | THPE based branched PC | pph | 66 | 66 | 66 | 66 | 66 | 66 |
| | | from high purity BPA2 | | | | | | | |
| PC | 91761 | High purity PC 175 | pph | 32.045 | 32.045 | 32.045 | 32.045 | 32.045 | 32.045 |
| PC | 91061 | High Purity PC | pph | 1 | 1 | 1 | 1 | 1 | 1 |
| Additive | F4455 | Potassium | pph | 0.08 | 0.08 | 0.08 | 0.08 | 0.08 | 0.08 |
| | | perfluorobutane, | | | | | | | |
| | | sulfonate | | | | | | | |
| Additive | F491 | Octaphenylcyclotetrasiloxane | pph | 0.35 | 0.35 | 0.35 | 0.35 | 0.35 | 0.35 |
| Additive | F538 | Pentaerythritol tetrastearate | pph | 0.35 | 0.35 | 0.35 | 0.35 | 0.35 | 0.35 |
| Additive | F542 | Phosphite stabilizer | pph | 0.06 | 0.06 | 0.06 | 0.06 | 0.06 | 0.06 |
| Additive | F6525 | Cyasorb UV-3638 | pph | 0.095 | 0.095 | 0.095 | 0.095 | 0.095 | 0.095 |
| Additive | F527 | Hindered phenol anti- | pph | 0.02 | 0.02 | 0.02 | 0.02 | 0.02 | 0.02 |
| | | oxidant | | | | | | | |
| Diffuser | R1540 | Cross linked PMMA beads | pph | 0.5 | 0.5 | 0 | 0 | 0 | 0 |
| Diffuser | R010722 | Tospearl ™ 120 | pph | 0.25 | 0.25 | 0.5 | 0.5 | 1 | 1 |
| TSAN | F449 | SAN encapsulated PTFE | pph | 0 | 0.2 | 0 | 0.2 | 0 | 0.2 |
| Typical | | | | | | | | | |
| Property | Test Method | Test Description | Unit | C2 | E4 | C3 | E5 | C4 | E6 |
| Luminous | Integrating | — | % | 97.1 | 97.45 | 95.2 | 96.15 | 93 | 93.45 |
| efficiency | sphere | | | | | | | | |
| Beam Angle | Goniophotometer | — | degree | 147.0 | 154.6 | 182.1 | 214 | 219 | 223.7 |

It was observed that at different diffusion levels, TSAN increases luminous efficiency and beam angle at the same time.

Table 5 presents an evaluation of flame retardant properties.

TABLE 5

| | Item | | | | | | | | |
|---|---|---|---|---|---|---|---|---|---|
| Item | Code | Item Description | Unit | C2 | E7 | E8 | E9 | E10 | E11 |
| PC | 91982 | THPE based branched PC | pph | 66 | 66 | 66 | 66 | 66 | 66 |
| | | from high purity BAP2 | | | | | | | |
| PC | 91761 | High purity PC 175 | pph | 32.045 | 32.045 | 32.045 | 32.045 | 32.045 | 32.045 |
| PC | 91061 | High Purity PC | pph | 1 | 1 | 1 | 1 | 1 | 1 |
| Additive | F4455 | Potassium perfluorbutane, | pph | 0.08 | 0.08 | 0.08 | 0.08 | 0.08 | 0.08 |
| | | sulfonate | | | | | | | |
| Additive | F491 | Octaphenylcyclotetrasiloxane | pph | 0.35 | 0.2 | 0.2 | 0.2 | 0.6 | |
| Additive | F323340 | Silicone oil (TSF437) | pph | 0 | 0.75 | 1.5 | 2.5 | 0.6 | 0.6 |
| Additive | F538 | Pentaerythitrol tetrastearate | pph | 0.35 | 0.2 | 0 | 0.2 | 0 | 0.2 |
| Additive | F542 | Phosphate stabilizer | pph | 0.06 | 0.06 | 0.06 | 0.06 | 0.06 | 0.06 |
| Additive | F6525 | Cytosorb ™ UV-3638 | pph | 0.095 | 0.095 | 0.095 | 0.095 | 0.095 | 0.095 |
| Additive | F527 | Hindered phenol antioxidant | pph | 0.02 | 0.02 | 0.02 | 0.02 | 0.02 | 0.02 |
| Diffuser | R010722 | Tospearl 120 | pph | 2 | 2 | 2 | 2 | 2 | 2 |
| TSAN | F449 | SAN encapsulated PTFE | pph | 0 | 0.2 | 0.2 | 0.2 | 0.2 | 0.3 |
| Typical | Test | | | | | | | | |
| Property | Method | Test Description | Unit | C2 | E7 | E8 | E9 | E10 | E11 |
| Flame | UL 94 | UL 94 | VO @ | VO @ | VO @ | VO @ | VO @ | VO @ | VO @ |
| Retardant | | | 1.5 mm | 0.75 mm | 0.75 mm | 0.75 mm | 0.75 mm | 0.75 mm | 0.75 mm |

It was observed that the combination of Silicone Oil, octaphenylcyclotetrasiloxane and TSAN improves FR rating (e.g., improved from VO @ 1.5 mm to VO @ 0.75 mm).

### Aspects

The present disclosure comprises at least the following aspects.

Aspect 1. An optical component comprising a polycarbonate-containing composition, the polycarbonate-containing composition comprising:

about 95 wt % to about 99.6 wt % polycarbonate polymer;

about 0.25 wt % to about 1 wt % silicon resin,

about 0.05 wt % to about 0.5 wt % flame retardant, and

about 0.1 wt % to about 0.5 wt % styrene-acrylonitrile copolymer coated polytetrafluoroethylene,

wherein the polycarbonate-containing composition exhibits a VO rating at 0.75 mm as determined by the UL94 Flammability test; and

wherein the total wt % of all components of the polycarbonate-containing composition does not exceed 100 wt %.

Aspect 2. The optical component of Aspect 1, wherein at least a portion of the polycarbonate is a branched polycarbonate.

Aspect 3. The optical component of Aspect 2, wherein the branched polycarbonate is produced from reagents comprising bisphenol A and 1,1,1-tris-(4-hydroxyphenylethane).

Aspect 4. The optical component of any one of Aspects 1-3, wherein the polycarbonate-containing composition comprises about 10 wt % to about 90 wt % branched polycarbonate.

Aspect 5. The optical component of any one of Aspects 1-4, additionally comprising one or more of anti-oxidant, UV stabilizer, and mold release agent.

Aspect 6. The optical component of any one of Aspects 1-5, wherein the optical component is formed by injection molding.

Aspect 7. The optical component of any one of Aspects 1-6 wherein the polycarbonate-containing composition exhibits an increased beam angle versus an analogous composition having no styrene-acrylonitrile copolymer coated polytetrafluoroethylene.

Aspect 8. The optical component of any one of Aspects 1-7, wherein the polycarbonate-containing composition exhibits increased luminous efficiency versus an analogous composition having no styrene-acrylonitrile copolymer coated polytetrafluoroethylene.

Aspect 9. The optical component of any one of Aspects 1-8, wherein the flame retardant comprises at least one compound of the formula

[(R)₂SiO]_{y}

wherein R is a monovalent hydrocarbon or fluorinated hydrocarbon having from 1 to 18 carbon atoms and y is a number from 3 to 12.

Aspect 10. The optical component of any one of Aspects 1-9, wherein the flame retardant is octaphenylcyclotetrasiloxane.

Aspect 11. The optical component of any one of Aspects 1-10 that is a LED lamp cover.

Aspect 12. The optical component of any one of claims 1-11, additionally comprising one or more phosphors.

Aspect 13. A LED light comprising a LED lamp cover of Aspect 11.

Aspect 14. A polycarbonate-containing composition comprising:

about 95 wt % to about 99.6 wt % polycarbonate polymer;

about 0.25 wt % to about 1 wt % silicon resin,

about 0.05 wt % to about 0.5 wt % flame retardant, and

about 0.1 wt % to about 0.5 wt % styrene-acrylonitrile copolymer coated polytetrafluoroethylene,

wherein the total wt % of all components of the polycarbonate-containing composition does not exceed 100 wt %

wherein the polycarbonate-containing composition exhibits a VO rating at 0.75 mm as determined by the UL94 flammability test; and

wherein the total wt % of all components of the polycarbonate-containing composition does not exceed 100 wt %.

Aspect 15. The polycarbonate-containing composition of Aspect 14, wherein at least a portion of the polycarbonate is a branched polycarbonate.

Aspect 16. The polycarbonate-containing composition of Aspect 14, wherein the branched polycarbonate is produced from reagents comprising bisphenol A and 1,1,1-tris-(4-hydroxyphenylethane).

Aspect 17. The polycarbonate-containing composition of any one of Aspects 14-16, wherein the polycarbonate-containing composition comprises about 10 to about 90 wt % branched polycarbonate.

Aspect 18. The polycarbonate-containing composition of any one of Aspects 14-17, additionally comprising one or more of anti-oxidant, UV stabilizer, and mold release agent.

Aspect 19. The polycarbonate-containing composition of any one of Aspects 14-18, wherein the optical component is formed by injection molding.

Aspect 20. The polycarbonate-containing composition of any one of Aspects 14-19 wherein the polycarbonate-containing composition exhibits an increased beam angle versus an analogous composition having no styrene-acrylonitrile copolymer coated polytetrafluoroethylene.

Aspect 21. The polycarbonate-containing composition of any one of Aspects 14-20, wherein the polycarbonate-containing composition exhibits increased luminous efficiency versus an analogous composition having no styrene-acrylonitrile copolymer coated polytetrafluoroethylene.

### Definitions

It is to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural equivalents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

Ranges can be expressed herein as from one particular value to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated±5% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as hole as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

As used herein, the terms “weight average molecular weight” or “Mw” can be used interchangeably, and are defined by the formula:

$${M}_{w} = \frac{Σ {N}_{i} {M}_{i}^{2}}{Σ {N}_{i} {M}_{i}} ,$$

where Mi is the molecular weight of a chain and Ni is the number of chains of that molecular weight. Mw can be determined for polymers, e.g. polycarbonate polymers, by methods well known to a person having ordinary skill in the art using molecular weight standards, e.g. polycarbonate standards or polystyrene standards, preferably certified or traceable molecular weight standards.

The abbreviation “LED” means “light emitting diode”.

An “analogous composition” is defined as being the same as the referred to composition except as noted in the description.

“PC” is the abbreviation for polycarbonate.

“TSAN” is an abbreviation representing styrene/acrylonitrile encapsulated polytetrafluoroethylene.

“TPHE” stands for tetrahydroxypropyl ethylenediamine. TPHE can be used in the production of branched polycarbonates.

The abbreviation “mm” represents millimeters. When used in terms of thickness, the measurement is at the thinnest portion of the article.

“Wt %” (or “wt %”) represents weight percent. Unless otherwise specified, wt % is based on the total weight of the composition.

“FR” stands for flame retardant.

“VO” represents the result of the UL 94 V-O test at a certain thickness.

The abbreviation “g” represents gram or grams.

“Mol” is the abbreviation for mole or moles.

“pph” is the abbreviation for parts per hundred.

“cm²” is centimeters squared.

“mm” is the abbreviation for millimeter(s).

“s” is second(s).

“° C.” is degrees Celsius.

“kg” is kilogram(s).

“pbw” is parts per weight.

‘hr” is hour(s).

“min” is minute(s).

“g” is gram(s).

“kgf/cm²” refers to a kilogram-force per square centimeter.

What is claimed:

1. An optical component comprising a polycarbonate-containing composition, the polycarbonate-containing composition comprising:
about 95 wt % to about 99.6 wt % polycarbonate polymer;
about 0.25 wt % to about 1 wt % silicon resin;
about 0.05 wt % to about 0.5 wt % flame retardant; and
about 0.1 wt % to about 0.5 wt % styrene-acrylonitrile copolymer coated polytetrafluoroethylene,
wherein the polycarbonate-containing composition exhibits a VO rating at 0.75 mm as determined by the UL94 Flammability test, and
wherein the total wt % of all components of the polycarbonate-containing composition does not exceed 100 wt %.

2. The optical component of claim 1, wherein at least a portion of the polycarbonate is a branched polycarbonate.

3. The optical component of claim 2, wherein the branched polycarbonate is produced from reagents comprising bisphenol A and 1,1,1-tris-(4-hydroxyphenylethane).

4. The optical component of claim 1, wherein the polycarbonate-containing composition comprises about 10 wt % to about 90 wt % branched polycarbonate.

5. The optical component of claim 1, additionally comprising one or more of anti-oxidant, UV stabilizer, and mold release agent.

6. The optical component of claim 1, wherein the optical component is formed by injection molding.

7. The optical component of claim 1, wherein the polycarbonate-containing composition exhibits an increased beam angle versus an analogous composition having no styrene-acrylonitrile copolymer coated polytetrafluoroethylene.

8. The optical component of claim 1, wherein the polycarbonate-containing composition exhibits increased luminous efficiency versus an analogous composition having no styrene-acrylonitrile copolymer coated polytetrafluoroethylene.

9. The optical component of claim 1, wherein the flame retardant comprises at least one compound of the formula
[(R)₂SiO]_{y}
wherein R is a monovalent hydrocarbon or fluorinated hydrocarbon having from 1 to 18 carbon atoms and y is a number from 3 to 12.

10. The optical component of claim 1, wherein the flame retardant is octaphenylcyclotetrasiloxane.

11. The optical component of claim 1, additionally comprising one or more phosphors.

12. The optical component of claim 1 that is a light emitting diode lamp cover.

13. A light emitting diode light comprising a LED lamp cover of claim 12.

14. A polycarbonate-containing composition comprising:
about 95 wt % to about 99.6 wt % polycarbonate polymer;
about 0.25 wt % to about 1 wt % silicon resin;
about 0.05 wt % to about 0.5 wt % flame retardant; and
about 0.1 wt % to about 0.5 wt % styrene-acrylonitrile copolymer coated polytetrafluoroethylene;
wherein the total wt % of all components of the polycarbonate-containing composition does not exceed 100 wt %,
wherein the polycarbonate-containing composition exhibits a VO rating at 0.75 mm as determined by the UL94 Flammability test, and
wherein the total wt % of all components of the polycarbonate-containing composition does not exceed 100 wt %.

15. The polycarbonate-containing composition of claim 14, wherein at least a portion of the polycarbonate is a branched polycarbonate.

16. The polycarbonate-containing composition of claim 14, wherein the branched polycarbonate is produced from reagents comprising bisphenol A and 1,1,1-tris-(4-hydroxyphenylethane).

17. The polycarbonate-containing composition of claim 14, wherein the polycarbonate-containing composition comprises about 10 to about 90 wt % branched polycarbonate.

18. The polycarbonate-containing composition of claim 14, wherein the optical component is formed by injection molding.

19. The polycarbonate-containing composition of claim 14, wherein the polycarbonate-containing composition exhibits an increased beam angle versus an analogous composition having no styrene-acrylonitrile copolymer coated polytetrafluoroethylene.

20. The polycarbonate-containing composition of claim 14, wherein the polycarbonate-containing composition exhibits increased luminous efficiency versus an analogous composition having no styrene-acrylonitrile copolymer coated polytetrafluoroethylene.
